(19) United States
(12) Patent Application Publication
(10) Pub. No.: US 2003/0033250 A1
(43) Pub. Date: Feb. 13, 2003

(54) System and method for automatic terminal management

(76) Inventors: Bob Mayes, Grove City, OH (US); Chris Drew, Westerville, OH (US); Paul Bassett, Newfields, NH (US); Stephen T. Keeran, Columbus, OH (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/094,658

(22) Filed: Mar. 12, 2002

Related U.S. Application Data
(60) Provisional application No. 60/311,130, filed on Aug. 10, 2001.

(51) Int. Cl. G06F 17/60

(52) U.S. Cl. 705/43

(57) ABSTRACT

The invention overcoming these and other problems in the art relates to a system and method for automatic terminal management via a network. The system of the invention comprises an electronic service order instructing a user to service at least one terminal, a data input module associated with a client for inputting by the user of updated terminal balance information relating to the at least one terminal serviced and for transferring to a server the updated terminal balance information. The client communicates with the server via a communication link. The system also includes a vendor module associated with the server for sending the order to the user and for receiving and storing the updated terminal balance information from the data module; a comparison module for determining discrepancies between the received updated terminal balance information with transaction data received from the at least one terminal serviced and for reconciling the terminal balance of the at least one terminal serviced; and a reconciliation module associated with the server for adjusting the terminal balances of the at least terminal serviced.

### FIELD OF THE INVENTION

The invention relates to the field of automated teller machine (ATM) management, and more particularly to a system for automatically handling vendor paperwork and reconciliation of ATM terminal balances.

### BACKGROUND OF THE INVENTION

The past thirty years have seen a significant change in the efficiency of banking and financial transactions. At the heart of this change is the ability of individuals and businesses to transfer and access funds electronically, such as through an automated teller machine (or ATM) or other electronic network. ATMs have revolutionized the way individuals bank by making cash available 24 hours a day, seven days a week, worldwide. Presently, there are an estimated 800,000 ATMs worldwide, with users in the United States depositing and withdrawing at least hundreds of millions of dollars each year.

The increase in cash flow resulting from ATM use has heightened the need for efficacious terminal management systems. Historically, banks have relied on the services of vendors (such as Brinks™ and NCR™) to stock cash and gather data on their ATM networks. Banks determine how much money is to be stocked in a particular ATM—ideal cash stocks depend on factors such as the location of the ATM, the history of transactions at the ATM, and seasonal considerations such as pre-holiday periods when consumer demand for cash may be higher than usual. Vendors then periodically replenish the ATMs based on the bank's assessment.

The typical terminal management process proceeds as follows. First, a bank issues (via facsimile, mail or e-mail) a scheduling order informing its vendor which ATMs to service, when the service is to take place, and how much cash to stock. The vendor then sends a handler to replenish the cash stocks, and to record transaction data accrued since the last service visit. Typical transaction data may include the total number of deposits and withdrawals, the total amount of deposits and withdrawals, and the available cash stock. The handler manually records the data in forms provided by the bank, and returns the completed forms to the bank via facsimile, mail, hand delivery, or other similar means. Banks use the gathered data to determine the appropriate amount of cash to stock in its ATM network, as well as for other monitoring and reporting purposes.

In addition, banks use the transaction data to reconcile terminal balance information received from the ATMs themselves. Normally, banks are electronically networked to their ATMs and are able to receive electronic transaction reports from each ATM concerning, among other things, the amount of cash withdrawn and deposited in a given period. It is possible, though, for an ATM to incorrectly report its transactions. For instance, assume a bank customer requests $40.00 from an ATM, but because of some mechanical or other problem receives only $20.00. Further assuming the ATM does not register the mistake, its electronic transaction report to the bank for that period would indicate a withdrawal of $40.00 and an available cash stock that is understated by $20.00. The manually gathered transaction data received from the vendor allows a bank to better monitor and ascertain ATM cash stocks, to verify the reports received from the ATMs, and to more efficiently investigate claims by customers who complain of improper account transactions.

Despite the benefits conferred by the above-described terminal management process between banks and vendors, it suffers from several drawbacks. First, manual entry of the gathered transaction data by the vendor may be error-prone and can distort ultimate balance figures and calculations. With no reliable mechanism in place to ensure efficient and accurate input of data by the handler, initial mistakes can further distort the bank's estimation of available cash stock at each of its ATMs.

Second, the use of forms to initiate servicing of ATMs and to communicate transaction data to a bank is time-consuming. Moreover, the forms can be misplaced or lost during transmission leading to wasteful and inefficient recovery procedures. These delays have the deleterious effect of leading to inefficient ATM cash stocks. For instance, storing too little cash in an ATM results in excessive vendor replenishment trips, while storing too much cash results in income losses to the bank in the form of unpaid interest that would have been realized had the excess cash been stored in an interest bearing account.

Lastly, the use of forms to communicate gathered data between vendor and bank prohibits the immediate provision of data to the bank on a global level. Presently, the vendor must provide a copy of the gathered data to each intended recipient. This creates a problem where, as in most banks, there are numerous departments that need to access the information.

### SUMMARY OF THE INVENTION

The invention overcoming these and other problems in the art relates to a system and method for automatic terminal management via a network. The system of the invention comprises an electronic service order instructing a user to service at least one terminal, a data input module associated with a client for inputting by the user of updated terminal balance information relating to the at least one terminal serviced and for transferring to a server the updated terminal balance information. The client communicates with the server via a communication link. The system also includes a vendor module associated with the server for sending the order to the user and for receiving and storing the updated terminal balance information from the data module; a comparison module for determining discrepancies between the received updated terminal balance information with transaction data received from the at least one terminal serviced and for reconciling the terminal balance of the at least one terminal serviced; and a reconciliation module associated with the server for adjusting the terminal balances of the at least terminal serviced.

In accordance with further aspects of the invention, the system further maintains current and historical values for the updated terminal balance information and the transaction data received from the at least one terminal.

Armed with updated terminal balance information a banking institution can better appreciate the amount of money residing in a particular ATM, as well as anticipate future replenishment schedules and amounts. Further, the system and method of the invention also allows a bank to better track, monitor, and reconcile transaction events so that mistakes and errors (be they human or mechanical) can be efficiently identified and remedied. Moreover, the electronic data inputted can be shared across numerous applications, as well as numerous bank terminals or locations.

### BRIEF DESCRIPTION OF THE DRAWINGS

The invention will be described with reference to the accompanying drawings, in which like elements are referenced with like numerals.

FIG. 1 illustrates a network architecture in which a vendor and bank can exchange information and data related to terminal management, according to an embodiment of the invention;

FIG. 2 illustrates a bank network station according to an embodiment of the invention;

FIG. 3 illustrates vendor module processing according to an embodiment of the invention;

FIG. 4 illustrates comparison module processing according to an embodiment of the invention;

FIG. 5 illustrates reconciliation module processing according to an embodiment of the invention.

### DETAILED DESCRIPTION OF THE INVENTION

The present invention provides a method and system for terminal management by creating an on-line platform for communication between vendors and banking institutions. Using the invention, a banking institution is able to electronically initiate servicing of ATMs (or terminals) by its vendor(s), and to electronically reconcile and adjust discrepancies and exceptions between terminal balances reported by the servicing vendor and the terminal itself. The vendor, on the other hand, is able to electronically receive the scheduling orders sent to it by the bank, and to electronically enter and transmit to the bank requested data related to the terminals serviced. Typical information inputted by a vendor into the on-line platform may include work date, name of terminal manager, handler name, terminal identification number, schedule type, cash totals received, cash totals dispensed, total number of stamp sheets dispensed per terminal receipt, total number of deposit envelopes received per terminal receipts, number of minutes spent by handler at terminal, and other information related to management of terminals or other dispenser terminals. Once this data is received by the bank, the system of the invention compares it to transaction data received directly from the terminals, and determines whether discrepancies or exceptions exist between the two. If discrepancies exist, the invention may reconcile the discrepancy itself, or permit a bank analyst to selectively reconcile each discrepancy on a case-by-case basis.

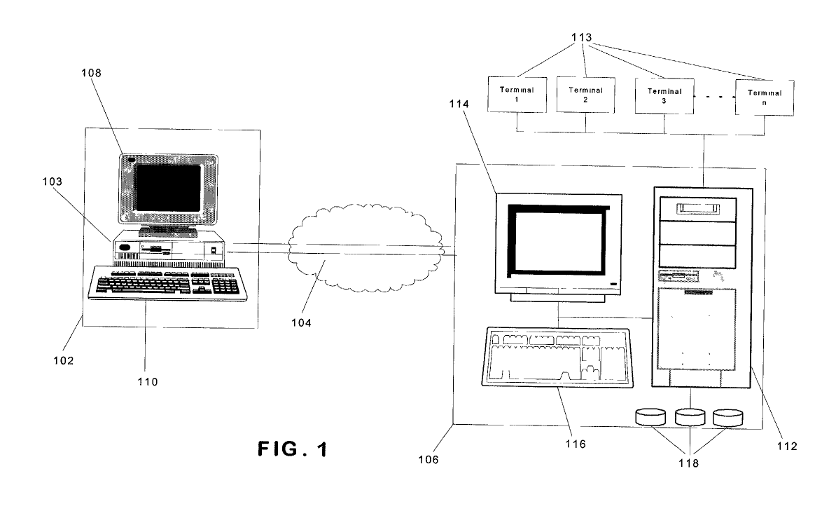

As illustrated in FIG. 1, in an embodiment of the invention a client 102 can access a network 106 via communications link 104. A vendor can use the client 102 to receive electronic scheduling orders from the bank and to input and transmit to the bank data related to the terminals serviced. The client 102 through which the user views the network 106 can include, for instance, a personal computer running Microsoft Windows™ 95, 98, Millenium™, NT™, or 2000, Windows™CE™, PalmOS™, Unix, Linux, Solaris™, OS/2™, BeOS™, MacOS™ or other operating system or platform. Client 102 may include a microprocessor such as an Intel x86-base device, a Motorola 68K or PowerPC™ device, a MIPS, Hewlett-Packard Precision™, or Digital Equipment Corp. Alpha™ RISC processor, a microcontroller or other general or special purpose device operating under programmed control. Client 102 may also be or include a network-enabled appliance such as a WebTV™ unit, radio-enabled Palm™ Pilot or similar unit, a set-top box, a browser-equipped cellular telephone, or other TCP/IP client or other device. The client 102 may have associated with it recordable media 103, such as an internal or external Zip™ drive, Jaz™ drive, recordable CD-ROM drive, fixed or removable hard drive, or other storage or other resources. Preferably, for reasons explained below, client 102 comprises a laptop personal computer or other portable device.

Client 102 includes vendor interface 108 through which graphical, textual, video, audio or other media are presented to the vendor to use and navigate the network site 106. For example, vendor interface 108 can display the scheduling order sent to the vendor by the bank informing the vendor what terminals to service, when they are to be serviced, how much cash to stock at each of the terminals, and other specific instruction(s) that may be relevant to all or particular terminals. The order can be displayed in standard text form or can be presented in an enhanced graphical fashion.

Client 102 also includes a data input module 110 that permits a vendor to enter data related to the terminals serviced. Once the vendor receives the scheduling order from the bank, a handler is dispatched to perform the requested services. Upon completion, the handler inputs the data gathered from that terminal into client 102 via data input module 110, and then transmits the same to network 106 (the bank) via communication link 104. If client 102 comprises a laptop computer or other portable device, the handler can input the gathered data while at the terminal site or location. Using a laptop computer or other portable device as client 102 is preferred to a desktop computer for several reasons. First, a laptop computer allows the handler to enter data while still at the terminal site thereby significantly reducing the likelihood of error involved with having to return to an office or other location to input the gathered data. Second, input of the gathered data at the terminal site and immediate delivery to network 106 ensures the bank will have timely and efficient access to the terminal data. Furthermore, a bank will be able to modify its initial service order in a timely and efficient manner. For instance, assume the bank would like to add (or remove) a terminal from the list of those to be serviced. If the handler is using a desktop station as client 102 he or she will not be aware of the change until he or she accesses the desktop computer (client 102), or someone else accesses the computer and informs the handler. Either way, the handler will not be immediately informed. However, if a laptop computer is used the bank's request will immediately reach the handler and his or her servicing of the terminals can be modified with little or no disruption.

The entering of data by the vendor into client 102 can be accomplished in several ways. First, data may be entered onto a formatted graphical chart that designates specific boxes or areas where the handler is to enter certain data, such as the available cash stock, the total number of deposits and withdrawals, total amount of deposits and withdrawals, etc. This chart can comprise the electronic service order sent by the bank to initiate service or a separate graphical chart. Using such a graphical chart will facilitate entry of the information by the handler and will thus reduce the likelihood of error. Alternatively, the data may be arranged by the handler in a text file having a predetermined format and subsequently transferred to network 106, such a via standard file transfer protocol (FTP).

The communications link 104 over which the client 102 accesses the network site 106 may include or interface to any one or more network resources such as, for instance, the Internet, an intranet, a PAN (Personal Area Network), a LAN (Local Area Network), a WAN (Wide Area Network), a MAN (Metropolitan Area Network), or an SAN (Storage Area Network). The communications link 104 may also include or interface with various types of connections such as, for example, a frame relay, an Advanced Intelligent Network (AIN), a synchronous optical network (SONET), a digital T1, T3, E1, or E3 lines, Digital Data Service (DDS), Digital Subscriber Line (DSL), Ethernet, ISDN (Integrated Services Digital Network), dial-up ports such as V.90, V.34 or V.4 bis analog modems, cable modems, ATM (Asynchronous Transfer Mode)m or an FDDI (Fiber Distributed Data Interface) or CDDI (Copper Distributed Data Interface).

Communications link 104 can further include or interface to any one or more of, for example, a WAP (Wireless Application Protocol) link, a GPRS (General Packet Radio Service) link, a GSM (Global System for Mobile Communication) link, a CDMA (Code Division Multiple Access) or TDMA (Time Division Multiple Access) link such as a cellular phone channel, a GPS (Global Positioning System) link, CDPD (cellular digital packet data), a RIM (Research in Motion, Limited) duplex paging type device, a Bluetooth radio link, or an IEEE 802.11-based radio frequency link. Communications link 104 may yet further be, include or interface to any one or more, for example, of an RS-232 serial connection, an IEEE-1394 (Firewire) connection, a Fibre Channel connection, a USB (Universal Serial Bus) connection or other wired or wireless, digital or analog interface or connection. Other communications links illustrated herein may be, include or interface to similar communications resources. The above examples of communications and other resources are illustrative rather than exhaustive, as will be apparent to those skilled in the art.

Network 106 can be accessed by a bank institution to initiate servicing of its terminal network and to reconcile terminal balances. Network 106 shows a server 112 that may include, for instance, a workstation running the Microsoft Windows™ NT™, Windows™ 2000, Unix, Linux, Xenix, IBM AIX™, Hewlett-Packard UX™, Novell Netware™, Sun Microsystems Solaris™, OS/2™, BeOS™, Mach, Apache, OpenStep™, or other operating system or platform. Server 112 is connected to the bank's terminal network 113 and is able to receive electronic transaction reports from each terminal on a periodic basis. The electronic transaction reports typically include information of interest to the bank such as the total number of deposits and withdrawals, the total amount of deposits and withdrawals, and the available cash stock.

Network 106 also includes an agent interface 114 through which graphical, textual, video, audio or other media are presented to the bank agent to interface and/or interact with client 102. For example, agent interface 114 can display the display the data gathered by the vendor and transmitted to the bank. The data can be received and displayed in a pre-determined graphical format or in a standard text file. Network 106 also includes a data input module 116 that permits a bank analyst or agent to enter information and/or data relating to the servicing of its terminals. It may be appreciated that although a single input module 116 and a single interface module 114 are shown in FIG. 1, the invention contemplates numerous such modules located throughout a bank and connected to server 112 so that information provided by the vendor can be accessed from more than one location.

Network 106 may also store information and data received from its vendors or in storage means 118. Storage means 118 may be, include or interface to, for example, the Oracle™ relational database sold commercially by Oracle Corporation. Other databases, such as InformiX™, DB2 (Database 2), Sybase or other data storage or query formats, platforms or resources such as OLAP (On Line Analytical Processing), SQL (Standard Query Language), a storage area network (SAN), Microsoft Access™ or others may also be used, incorporated or accessed in the invention. Alternatively, the vendor can provide the requested to the bank through an off-line method such as a file transfer protocol (FTP) transfer, or similar method.

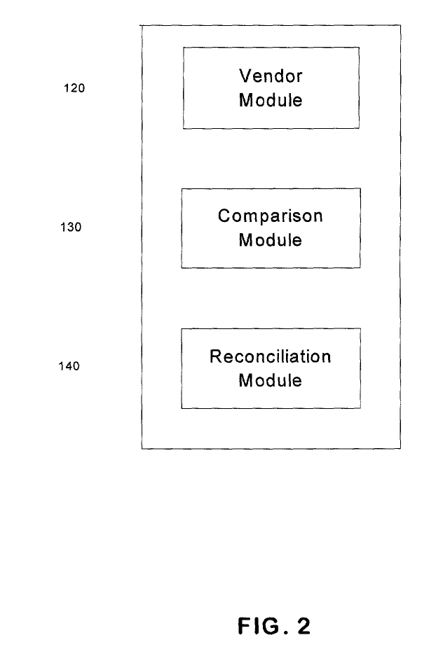

As shown in FIG. 2, server 112 has associated with it vendor module 120, comparison module 130, and reconciliation module 140. Vendor module 120 allows an analyst of the banking institution to electronically prepare and submit to a vendor at client 102 the particular scheduling order for replenishment of ATMs. Likewise, vendor module 120 can receive from a handler (via client 102) the gathered transaction data regarding each terminal serviced. Specifically, vendor module 120 presents the particular graphical interface (or electronic form) used by the bank and the vendor to communicate information and data related to servicing of the bank's terminal network 113. Vendor module 120 thus processes the “paperwork” between a bank and its vendors.

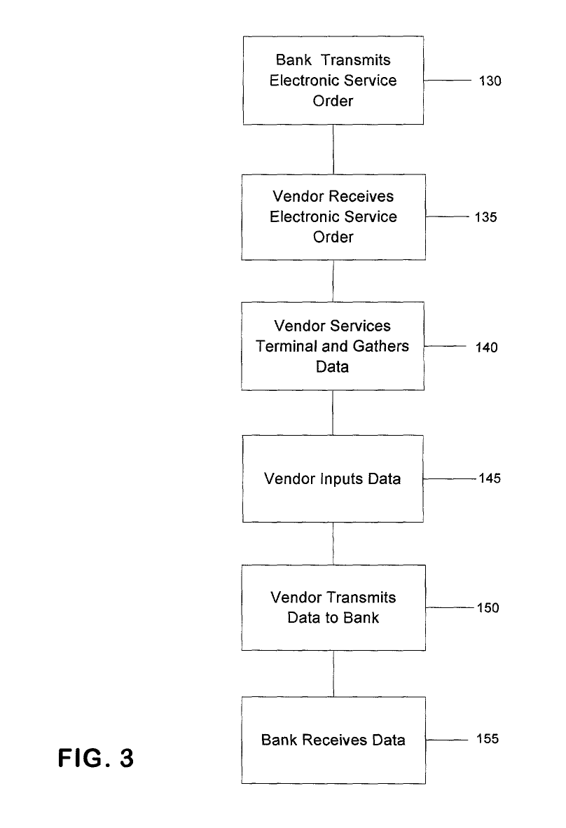

As shown in FIG. 3, processing by vendor module 120 commences at step 130 when a bank analyst or agent transmits to its vendor an electronic service order. In so doing, the bank agent or analyst inputs the required information into vendor module 120 using data input module 116. The information provided to the vendor may include ATM identification numbers, locations of the ATM, vendor identification number and/or name, amount of cash to replenish or remove, and other relevant information. Next, at step 135, the vendor receives the electronic service order and, at step 140, proceeds to service the terminals and gather the requested transaction data. When servicing is complete, the analyst, at step 145, inputs the transaction data into client 102 using data input module 110 and transmits the same to the bank, as shown at steps 150 and 155. Transmission of information and data between the vendor and the bank is transmitted via communications link 104 and received, processed and formatted by vendor module 120. The information and data processed by vendor module 120 may appear in either textual or enhanced graphical format. Once received by the bank, the data can be accessed by any agent or analyst having proper access rights to network 106.

Server 112 also includes a comparison module 130 that serves to identify discrepancies between the transaction data provided by the vendor and transaction data received from the individual terminals of network 113. As shown in FIG. 1, terminals 1, 2, 3, . . . n, are electronically connected to server 112 and are able to transmit electronic transaction reports periodically. As mentioned above, these reports provide the bank with data similar to that provided by the vendors, e.g., cash balances, number of deposits and withdrawals, etc. Differences between the vendor data and the transaction report can result. First, the terminal may have dispensed more cash than otherwise reported as in the instance where a customer requests $40.00 but because of mechanical failure receives only $20.00. Unless the terminal recognizes the mistake, the data gathered by the vendor will be different than that provided by the terminal. Specifically, the data provided by the vendor would indicate the actual amount of cash stored in the terminal, while the terminal report would be $20.00 less. The difference, of course, would be different if more than one error had occurred. Likewise, a customer can receive more cash than requested leading to the transaction report overstating the actual cash stock.

In the event comparison module 130 identifies a situation where the data received from a terminal is less than that received from the vendor, it can be preprogrammed to automatically reconcile the terminal balance by arranging for transfer of cash from the bank's general ledger account to the particular terminal. For example, assume the cash stock reported by the terminal is $20.00 more than that reported by the vendor. This may result from a situation where a customer requests $20.00 from a terminal, but because of an error actually received $40.00. Upon spotting this discrepancy, comparison module 130 can automatically issue an electronic general ledger ticket that authorizes the transfer of funds from the bank's general ledger account to the particular terminal during the next scheduled vendor visit. Comparison module 130 can be preprogrammed to conduct reconciliation at a particular frequency such as, for example, at the close of business each day. Further, for security reasons automatic reconciliation can occur up to a predetermined amount. For example, the bank may prefer that any discrepancy greater than $50.00 be first approved by a supervisor prior to reconciliation occurring. Comparison module 130 can also calculate vendor vault and cash balances for all terminals, perform automated comparisons of terminal and vendor vault cash balances, retain balance and transaction history for research and reporting purposes, calculate total deposits and re-deposits, and calculate total vault-to-vault transfers.

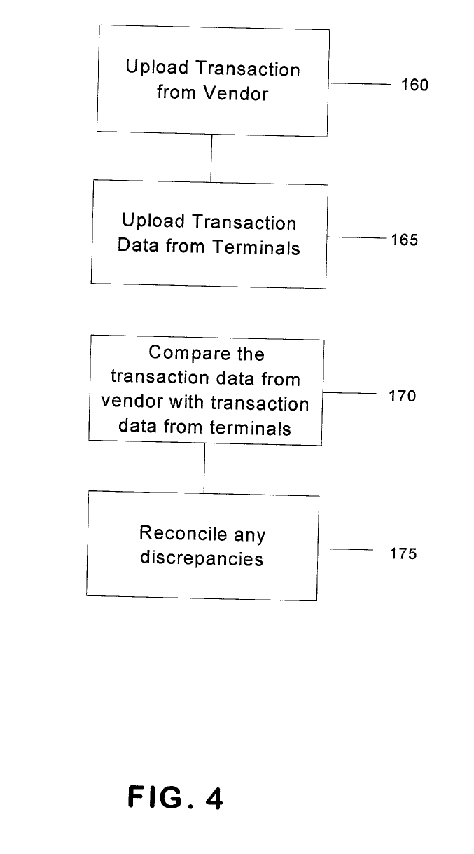

FIG. 4 illustrates a process flow chart of comparison module 130. First, the transaction data received from the vendor at vendor module 120 is accessed as shown at step 160. Next, at step 165, the transaction data from the terminal is accessed and then compared to the data from the vendor at step 170. At step 175, any discrepancy between the two is automatically reconciled by comparison module 130.

Server 110 also includes a reconciliation module 140 that permits a bank analyst to manually make on-line adjustments of terminal balances in response to customer claims. Many times a bank customer will request a withdrawal of a certain amount of money from a terminal only to receive much less, even though his account balance reflects a withdrawal of the full amount requested. Usually, the customer will complain to a bank analyst who must verify the error and reimburse the customer. Using reconciliation module 140 the bank analyst can access historical comparison data stored by comparison module 130 to determine whether or not on the day the customer complains about there was a discrepancy between the cash stock reported by the vendor and that reported by the terminal. If there was a discrepancy, the reconciliation module 140 is able to generate an electronic general ledger ticket that authorizes a transfer of the disputed funds from the general ledger account directly to the customer's account.

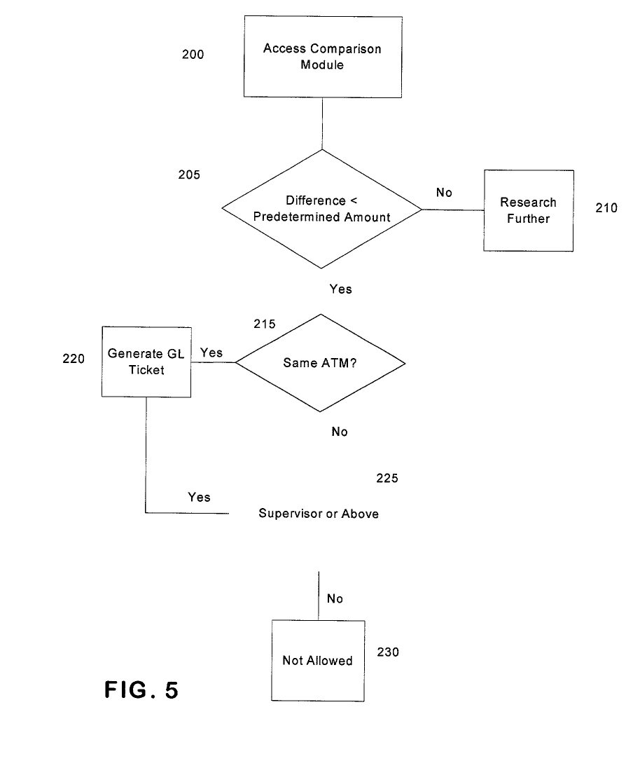

FIG. 5 shows the process flow chart of reconciliation module 140. Upon being selected by a bank analyst, reconciliation module 140, at step 200, accesses historical data of comparison module 130 stored in storage means 118 and checks the vendor data and the transaction report from the terminal for the date on which the customer alleges he was short changed. If there was a discrepancy between the two on that date, reconciliation module 140, at step 205, checks to see if the discrepancy is less than or equal to a predetermined amount. This allows the bank to further investigate exceedingly large discrepancies in an effort to prevent fraudulent claims. If the discrepancy is less than the predetermined amount, reconciliation module 140, at step 215, checks to see if the discrepancy occurs at the same terminal visited by the complaining customer. If yes, reconciliation module 140 issues an instruction to generate a general ledger ticket authorizing a transfer of funds from the bank's general ledger account to the customer's account. If not, however, reconciliation module 140 awaits determination by a supervisor as to whether or not the customer should be reimbursed.

The foregoing description of the system and method of this invention is illustrative, and variations in configuration and implementation will occur to persons skilled in the art. For instance, while the client 102 has been described as a singular platform, in implementations client 102 may consist of more than one device or resource. Other computing or other resources described as separate can be combined into one, or computing or other resources described as singular can be described amongst different platforms in different implementations.

In an alternative embodiment, the system and method of the invention can be used to replenish and monitor machines that dispense items other than cash such as, for example, tokens, phone cards, traveler's checks. Like ATMs, these types of machines also have stocks that are depleted as use continues. Accordingly, the benefits addressed above similarly applies.

In yet another alternative embodiment, client 102 may provide transaction data to network 106 automatically without the need of human intervention. In this instance, client 102 is associated with or made a part of each terminal from which transaction data is requested. Client 102 may be preprogrammed to periodically ascertain the available cash stock and to report the amount to network 106 via communications link 104. Other data, such as the number and amount of deposits and withdrawals may also be determined by client and automatically delivered to network 106.

The scope of the invention is accordingly intended to be limited only by the following claims.

What is claimed is:

1. A system for the management of terminal operations, comprising:
an interface to at least one dispensing terminal;
storage means, communication with the interface to at least one dispensing terminal, the storage means storing data relating to the at least one dispensing terminal; and
at least one access port, the access port communicating with the storage means via a communications link.

2. The system of claim 1 wherein the at least one access ports comprises a plurality of access ports.

3. The system of claim 2 wherein the plurality of access ports comprises at least any two of a remote maintenance port, an internal bank port and an Internet port.

4. The system of claim 1 wherein the storage means comprises a database.

5. The system of claim 4 wherein the database comprises a relational database.

6. The system of claim 4 wherein the storage means further comprises back up means to protect against loss of data.

7. The system of claim 4 wherein data stored in the storage means comprises at least one of an amount of cash stored, a number of deposits, a number of withdrawals, an amount of deposits, an amount of withdrawals, a time of deposits, a time of withdrawals, a date of deposits and a date of withdrawals at the at least one dispensing terminal.

8. The system of claim 1 further comprising a second storage means for storing a subset of the data stored in the storage means upon request by a user of the at least one access port.

9. The system of claim 1 further comprising a client associated with the at least one dispensing terminal, the client for gathering and delivering to the storage means the data related to the at least one cash dispensing terminal via the communications link.

10. The system of claim 9 wherein the client delivers the data automatically.

11. The system of claim 1, wherein the at least one dispensing terminal comprises a cash dispensing terminal.

12. A system for automatic terminal management via a network, comprising:
an electronic service order instructing a user to service at least one terminal;
a data input module associated with a client for inputting by the user of updated terminal balance information relating to the at least one terminal serviced and for transferring to a server the updated terminal balance information, the data input module communicating with the server via a communication link;
a vendor module associated with the server for sending the service order to the user and for receiving and storing the updated terminal balance information from the data module;
a comparison module for determining discrepancies between the received updated terminal balance information with transaction data received from the at least one terminal serviced and for reconciling the terminal balance of the at least one terminal serviced; and
a reconciliation module for adjusting the terminal balance of the at least one terminal serviced.

13. The system of claim 12 wherein the comparison module reconciles the terminal balance automatically.

14. The system of claim 12 wherein the electronic service order comprises a graphical interface having a plurality of input boxes wherein specific data is to be input by the user.

15. The system of claim 12 wherein the server maintains current and historical values for updated terminal balance information and transaction data received from the at least one terminal.

16. The system of claim 12 wherein the client comprises at least one of a computer, a network-enabled telephone device, and a personal digital assistant.

17. The system of claim 12 wherein the communication link comprises at least one of the Internet, an intranet, and a LAN.

18. A method for automatic terminal management via a network, comprising the steps of:
a) transmitting an order via a communications link to a client for instructing a user to replenish at least one terminal;
b) receiving updated terminal balance information from the user via the communication link;
c) comparing the updated terminal balance information received from the user with transaction data received from the at least one terminal;
d) determining discrepancies between the updated terminal balance information and transaction data received from the at least one terminal serviced; and
e) adjusting the discrepancies between the updated terminal balances information and the transaction data.

19. The method of claim 18 wherein the step e) of adjusting the discrepancies between the updated terminal balances information and the transaction data occurs automatically.

20. The method of claim 18 wherein the client comprises at least one of a computer, a network-enabled telephone device, and a personal digital assistant.

21. The method of claim 18 wherein the communication link comprises at least one of the Internet, an intranet, and a LAN.
